(19) United States
(12) Patent Application Publication
(10) Pub. No.: US 2025/0038612 A1
(43) Pub. Date: Jan. 30, 2025

(54) MOTOR AND BLOWER

(71) Applicant: NIDEC CORPORATION, Kyoto (JP)

(72) Inventors: Masafumi FUJIMOTO, Kyoto (JP); Risa HIRAYAMA, Kyoto (JP)

(21) Appl. No.: 18/779,429

(22) Filed: Jul. 22, 2024

(30) Foreign Application Priority Data
Jul. 28, 2023 (JP) 2023-123792

(51) Int. Cl. H02K 5/10; H02K 1/18; H02K 5/15; H02K 7/08

(52) U.S. Cl. CPC H02K 5/10; H02K 1/18; H02K 5/15; H02K 7/08

(57) ABSTRACT

A motor includes a rotor, a stator, and a labyrinth portion. The rotor is rotatable about a central axis extending in an axial direction. The stator includes a stator core. In the stator core, a labyrinth portion in which coils arranged in a circumferential direction are located includes a pair of metal cylindrical portions surrounding the central axis. The pair of metal cylindrical portions includes a pair of opposing surfaces that oppose each other in a radial direction with a gap therebetween, and one of the opposing surfaces surrounds the other.

### CROSS-REFERENCE TO RELATED APPLICATIONS

The present application claims priority under 35 U.S.C. § 119 to Japanese Patent Application No. 2023-123792, filed on Jul. 28, 2023, the entire contents of which are hereby incorporated herein by reference.

### 1. FIELD OF THE INVENTION

The present disclosure relates to a motor and a blower.

### 2. BACKGROUND

Conventionally, a motor having a labyrinth structure including a pair of protrusions facing each other in a radial direction is known. For example, in a motor, a protrusion provided on the winding side from a boss portion of the impeller radially faces a projection formed on an upright portion of a bearing box to form a labyrinth structure.

However, for weight reduction, cost reduction, and the like, the cup portions of the impeller and the rotor are formed using a resin material. Therefore, usually, at least the above-described protrusions on the impeller side are also made of resin. For example, as compared with a metal component, a resin component tends to have a large dimensional tolerance, so that it is difficult to reduce a gap between opposing surfaces of protrusions facing each other in the radial direction of the labyrinth structure. In addition, if the dimensional tolerance is estimated to be small, there is a possibility that a gap is eliminated at least locally between the facing surfaces of the protrusions. That is, since the protrusion on the impeller side or the rotor side may at least locally come into contact with the protrusion on the bearing box side, sliding between the protrusions may adversely affect the rotation of the motor.

### SUMMARY

An example embodiment of a motor of the present disclosure includes a rotor, a stator, and a labyrinth portion. The rotor is rotatable about a central axis extending in an axial direction. The stator includes a stator core. In the stator core, a labyrinth portion in which coils aligned in a circumferential direction are located includes a pair of metal cylindrical portions surrounding the central axis. The pair of metal cylindrical portions includes a pair of opposing surfaces that oppose each other in a radial direction with a gap therebetween and one of the opposing surfaces surrounds the other.

An example embodiment of a blower according to the present disclosure includes the motor and rotor blades. The rotor blade is rotatable about the central axis together with the rotor of the motor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating an example configuration of a blower according to an example embodiment of the present disclosure.

FIG. 2 is a perspective view illustrating the appearance of a blower according to an example embodiment of the present disclosure.

FIG. 3 is an enlarged cross-sectional view of a portion III surrounded by a broken line in FIG. 1.

FIG. 4 is an enlarged cross-sectional view of a portion IV surrounded by a broken line in FIG. 1.

FIG. 5 is an enlarged cross-sectional view of a portion V surrounded by a broken line in FIG. 1.

### DETAILED DESCRIPTION

Example embodiments will be described with reference to the drawings hereinafter.

In the present specification, in a blower 100 and a motor 101, a direction parallel to a central axis CA is referred to as an “axial direction”. Of the axial directions, a direction from a base portion 32 to a rotor hub 11 described later is referred to as “one axial direction Da”, and a direction from the rotor hub 11 to the base portion 32 is referred to as “the other axial direction Db”. A direction orthogonal to the central axis CA is referred to as a “radial direction”, and a rotation direction around the central axis CA is referred to as a “circumferential direction”. In the radial directions, a direction approaching the central axis CA is referred to as “radially inward Di”, and a direction away from the central axis CA is referred to as “radially outward Do”.

In this specification, an “annular shape” includes not only a shape continuously connected without any cut along the entire circumference in the circumferential direction around the central axis CA, but also a shape having one or more cuts in a part of the entire circumference around the central axis CA. The “annular shape” also includes a shape having a closed curve on a curved surface that intersects with the central axis CA around the central axis CA.

In addition, in a positional relationship between any one of an azimuth, a line, and a plane and another, “parallel” includes not only a state in which both of them do not intersect at all no matter how long they extend, but also a state in which they are substantially parallel. In addition, “perpendicular” and “orthogonal” include not only a state in which both of them intersect each other at 90 degrees, but also a state in which they are substantially perpendicular and a state in which they are substantially orthogonal. In other words, each of “parallel”, “perpendicular”, and “orthogonal” includes a state in which the positional relationship between the two of them permits an angular deviation to a degree not departing from the spirit of the present disclosure.

It is to be noted that the above names are names used merely for description, and are not intended to limit actual positional relationships, directions, names, and the like.

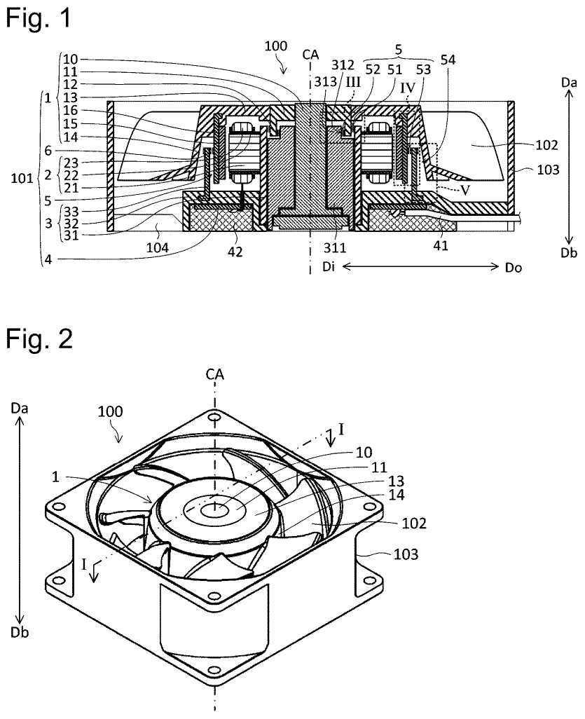

FIG. 1 is a cross-sectional view illustrating an exemplary configuration of the blower 100. FIG. 2 is a perspective view illustrating the appearance of the blower 100. FIG. 1 illustrates a cross-sectional structure when the blower 100 is virtually cut along a plane including the two-dot chain line I-I and the central axis CA in FIG. 2.

The blower 100 of the present example embodiment is an axial fan, and sends out an air flow sucked from one axial direction Da to the other axial direction Db. However, this example does not exclude a configuration in which the blower 100 is other than the axial fan. For example, the blower 100 may be a blower fan or a centrifugal fan.

As illustrated in FIGS. 1 and 2, the blower 100 includes a motor 101 and rotor blades 102. The rotor blades 102 are rotatable about the central axis CA together with the rotor 1 of the motor 101 described later. In the present example embodiment, a plurality of rotor blades 102 are disposed on the radially outer surface of the rotor 1 and aligned in the circumferential direction. When the motor 101 rotates the rotor blades 102 in the circumferential direction, the airflow flows in the axial direction.

The blower 100 further includes a cylindrical casing 103 and a rib 104. The cylindrical casing 103 extends in the axial direction and surrounds the motor 101 and the rotor blades 102. The cylindrical casing 103 faces the motor 101 in the radial direction with a gap, and forms a wind tunnel through which an air flow flows in a space between the cylindrical casing and the motor 101. The ribs 104 extend at least in the radial direction and are arranged side by side in the circumferential direction on the other axial direction Db side of the wind tunnel. The rib 104 functions as a stator vane that rectifies the airflow flowing in the wind tunnel. The rib 104 connects the base portion 32 of the motor 101 and the other axial end of the cylindrical casing 103. That is, the radially inner end of the rib 104 is connected to the base portion 32. The radially outer end of the rib 104 is connected to the radially inner surface of the cylindrical casing 103.

In the blower 100 of the present example embodiment, as will be described later, it is possible to further reduce the gap while securing the gap between opposing surfaces fi and fo in a labyrinth portion 5 of the motor 101. Therefore, it is possible to suppress or prevent entry of water and dust from the radially outward Do side to the radially inward Di side of the labyrinth portion 5.

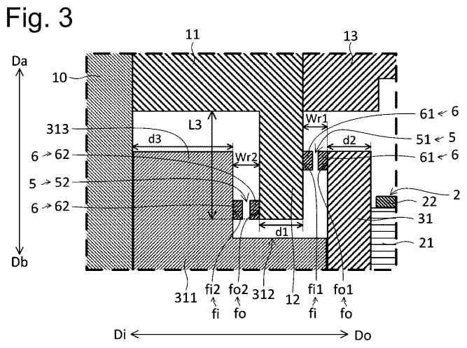

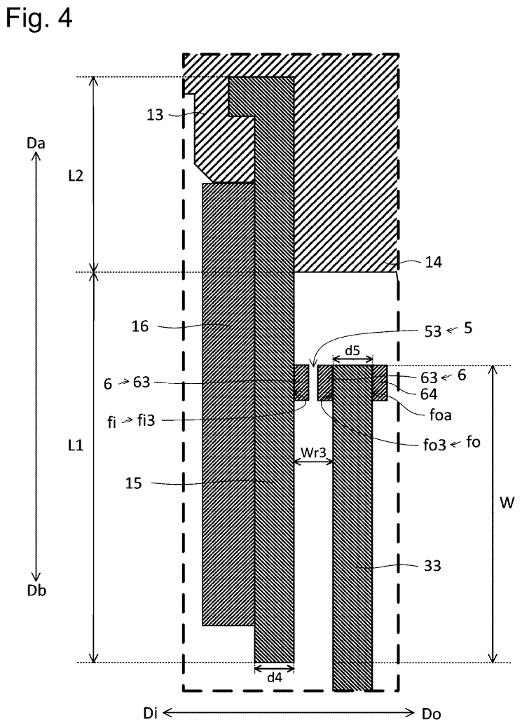

Next, an exemplary configuration of the motor 101 will be described with reference to FIGS. 1 to 4. FIG. 3 is an enlarged cross-sectional view of a portion III surrounded by a broken line in FIG. 1. FIG. 4 is an enlarged cross-sectional view of a portion IV surrounded by a broken line in FIG. 1.

As illustrated in FIG. 1, the motor 101 includes the rotor 1, a stator 2, a housing 3, a circuit board 4, the labyrinth portion 5, and a water-repellent layer 6.

The rotor 1 is rotatable about the central axis CA extending in the axial direction. As described above, the motor 101 includes the rotor 1. The rotor 1 includes a shaft 10, a rotor hub 11, a protruding wall portion 12, a rotor lid 13, a rotor cylindrical portion 14, a first peripheral wall portion 15, and a magnet 16.

The shaft 10 extends in the axial direction along the central axis CA and is rotatably supported by a bearing 311. As described above, the rotor 1 includes the shaft 10. The shaft 10 is rotatable about the central axis CA. That is, in the present example embodiment, the shaft 10 is a rotation axis. However, the present disclosure is not limited to this example. The shaft 10 may be a fixed shaft fixed together with the stator 2 or may not be rotatable about the central axis CA. In the case of a fixed shaft, a bearing that rotatably supports the rotor hub 11 with respect to the shaft 10 is arranged between the shaft 10 and the rotor hub 11.

In the present example embodiment, as illustrated in FIG. 1, the rotor hub 11 is fixed to one axial end of the shaft 10. As described above, the rotor 1 includes the rotor hub 11. The rotor hub 11 extends radially outward Do from one axial end of the shaft 10.

The protruding wall portion 12 is a metal cylindrical member extending in the axial direction and surrounds the central axis CA. As described above, the rotor 1 includes the protruding wall portion 12. The cylindrical protruding wall portion 12 extends from the other axial end face of the rotor hub 11 to the other axial end Db, and surrounds one axial end of the bearing 311. The protruding wall portion 12 is integrated with the rotor hub 11 in the present example embodiment. However, the present disclosure is not limited to this example, and the protruding wall portion 12 may be a member separate from the rotor hub 11.

The rotor lid 13 is disposed on the one axial direction Da with respect to the stator 2 and extends in the radial direction. As described above, the rotor 1 includes the rotor lid 13. Specifically, the rotor lid 13 has an annular shape surrounding the rotor hub 11, and extends radially outward Do from the radially outer end of the rotor hub 11.

The rotor cylindrical portion 14 is a cylindrical member extending in the axial direction, and is made of resin in the present example embodiment. However, the present disclosure is not limited to this example. The rotor cylindrical portion 14 may be made of metal. The rotor cylindrical portion 14 extends in the other axial direction Db from the radially outer end of the rotor lid 13. As described above, the rotor 1 includes the rotor cylindrical portion 14. The rotor cylindrical portion 14 has a cylindrical truncated cone shape surrounding the stator 2 in the present example embodiment, and extends radially outward Do toward the other axial direction Db in FIG. 1. However, the present disclosure is not limited to this example, and the rotor cylindrical portion 14 may have a cylindrical shape extending in the axial direction.

In the present example embodiment, a plurality of rotor blades 102 are disposed on the radially outer surface of the rotor cylindrical portion 14. That is, the rotor 1 includes the plurality of rotor blades 102. Each of the plurality of rotor blades 102 extends radially outward Do from the radially outer surface of the rotor cylindrical portion 14 and extends at least in the axial direction. The rotor cylindrical portion 14, the rotor lid 13, and the plurality of rotor blades 102 are integrated to form a single member. However, the present disclosure is not limited to this example, and at least one of the rotor blade 102, the rotor lid 13, and the rotor cylindrical portion 14 may be a separate body. The plurality of rotor blades 102 may be separate from the rotor 1. For example, the motor 101 may have an impeller. The impeller may include an impeller base and the plurality of rotor blades 102. The impeller base may have a covered cylindrical shape extending in the axial direction and opening in the other axial direction Db, and may be attached to one axial end of the rotor 1. The plurality of rotor blades 102 may be disposed on the radially outer surface of the impeller base and aligned in the circumferential direction.

The first peripheral wall portion 15 is a metal cylindrical member extending in the axial direction and surrounds the central axis CA. In the present example embodiment, the first peripheral wall portion 15 is a cylindrical magnetic body extending in the axial direction. As described above, the rotor 1 includes the first peripheral wall portion 15. The cylindrical first peripheral wall portion 15 extends in the other axial direction Db from the other axial end surface of the rotor lid 13 to surround the stator 2. However, the present disclosure is not limited to this example, and the first peripheral wall portion 15 may extend in the other axial direction Db from the radially inner surface of the rotor cylindrical portion 14. That is, a portion of the first peripheral wall portion 15 on the one axial direction Da side is connected to either the other axial end of the rotor lid 13 or the radially inner end of the rotor cylindrical portion 14. For example, a portion of the first peripheral wall portion 15 on the one axial direction Da side is formed integrally with at least one of the rotor lid 13 and the rotor cylindrical portion 14 by insert molding or the like. Therefore, as illustrated in FIGS. 1 and 3, the portion on the one axial direction Da side of the first peripheral wall portion 15 may be embedded in either the rotor lid 13 or the rotor cylindrical portion 14. Alternatively, the portion on the one axial direction Da side of the first peripheral wall portion 15 may be inserted into the cylindrical radially inner end of the rotor cylindrical portion 14, and fixed to the cylindrical radially inner end of the rotor cylindrical portion 14 by means of press fitting, adhesion, or the like.

The magnet 16 is disposed on the radially inner surface of the first peripheral wall portion 15, and radially faces the stator 2 (In particular, a stator core 21 to be described later). As described above, the rotor 1 includes the magnet 16. The magnet 16 is disposed radially outward Do of the stator 2 (particularly the stator core 21) and surrounds the stator 2 (particularly the stator core 21). In the magnet 16, a plurality of different magnetic poles (S pole, N pole) are alternately arranged in the circumferential direction.

Preferably, as illustrated in FIG. 4, an axial length L1 of a portion of the first peripheral wall portion 15 exposed from either one of the rotor lid 13 and the rotor cylindrical portion 14 is longer than an axial length L2 of a portion connected to either one of the rotor lid 13 and the rotor cylindrical portion 14.

Accordingly, the axial length L1 of the exposed portion of the first peripheral wall portion 15 of the magnetic body can be further increased. Therefore, the first peripheral wall portion 15 easily dissipates the heat transmitted from the magnet 16. Therefore, the heat dissipation of the magnet 16 can be improved.

In addition, the axial width W (see FIG. 4) of a pair of third opposing surfaces fi3 and fo3 can be made longer. Accordingly, since a third water-repellent layer 63 to be described later can be disposed in a desired region in the axial direction of the third opposing surfaces fi3 and fo3, the degree of freedom in the layout of the arrangement position of the third water-repellent layer 63 is increased. Alternatively, the axial width W of the third water-repellent layer 63 can be made wider. Therefore, it is possible to further improve the effect of suppressing or preventing the intrusion of water and dust into the motor 101 (particularly the stator 2).

The stator 2 rotates the rotor 1 by the magnetic flux generated by energization. As illustrated in FIG. 1, the stator 2 includes the stator core 21, an insulator 22, and a coil 23.

The stator core 21 is an annular magnetic body surrounding the central axis CA, and in the present example embodiment, is a laminated body in which plate-shaped electromagnetic steel plates extending in the radial direction are laminated in the axial direction. The stator core 21 is fixed to the radially outer surface of the stator holder 31. In addition, the stator core 21 has slots (not illustrated). The plurality of slots penetrate the stator core 21 in the axial direction and are aligned in the circumferential direction. In the stator core 21, a plurality of coils 23 aligned in the circumferential direction are disposed. As described above, the stator 2 includes the stator core 21.

The insulator 22 has electrical insulation, and is disposed on surfaces of the stator core 21 (particularly, both end surfaces in the axial direction, the inner side surface of the slot, and the like).

The coil 23 is a member in which a conductive wire (reference numeral is omitted) is arranged in a coil shape on the stator core 21 via the insulator 22. The conductive wire is, for example, an enamel-coated copper wire, a metal wire coated with an electrically insulating member, or the like, and is wound around a tooth (not illustrated) between slots adjacent to each other in the circumferential direction of the stator core 21 to form the coil 23. When a drive current is supplied to each of the coils 23, the stator 2 is excited to drive the rotor 1.

The housing 3 includes a stator holder 31, a base portion 32, and a second peripheral wall portion 33.

The stator holder 31 is a metal cylindrical member extending in the axial direction and surrounds the central axis CA. The stator holder 31 extends in the axial direction and supports the stator core 21. As described above, the housing 3 includes the stator holder 31. In other words, the motor 101 includes the stator holder 31. The stator holder 31 has a cylindrical shape that surrounds the central axis CA and extends in the axial direction, and holds the stator core 21 on its radially outer surface.

The one axial end of the stator holder 31 is disposed radially outward Do of the protruding wall portion 12 of the rotor 1. The protruding wall portion 12 (particularly, a portion on the other axial direction Db side) is inserted into the inside (radially inward side) of one axial end of the stator holder 31, and radially faces the one axial end of the stator holder 31 with a gap.

On the cylindrical inner peripheral surface (that is, radially inner surface) of the stator holder 31, a bearing 311 is disposed and the shaft 10 is inserted therethrough. The stator holder 31 rotatably supports the shaft 10 via the bearing 311.

The bearing 311 is disposed on the inner peripheral surface (that is, the radially inner surface) of the stator holder 31. The motor 101 includes the bearing 311. The bearing 311 is a metal cylindrical member extending in the axial direction and surrounding the shaft 10, and is a sleeve functioning as a fluid dynamic bearing in the present example embodiment. A fluid (not illustrated) such as lubricating oil is disposed between the shaft 10 and the bearing 311. On at least one of the radially outer surface of the shaft 10 and the radially inner surface of the bearing 311, a dynamic pressure groove (not illustrated) for generating a dynamic pressure in the fluid interposed therebetween is disposed. When the shaft 10 rotates, the dynamic pressure groove generates a dynamic pressure in the fluid therebetween. This dynamic pressure separates the bearing 311 and the shaft 10. As a result, the rotating shaft 10 is supported in a non-contact state with the bearing 311.

One axial end of the bearing 311 is annularly cut out at the radially outer end. In other words, the bearing 311 has a recess 312. The recess 312 has a tubular shape surrounding the central axis CA and extends in the axial direction. As illustrated in FIG. 3, the recess 312 is recessed in the other axial direction Db at one axial end of the bearing 311, and is opened radially outward Do. The other axial end (that is, the inner surface facing the one axial direction Da) of the recess 312 is disposed closer to the other axial end direction Db side than the protruding wall portion 12, and axially faces the other axial end surface of the protruding wall portion 12 with a gap.

The radially inner surface (that is, the inner surface facing radially outward Do) of the recess 312 is disposed radially inward Di of the protruding wall portion 12 of the rotor 1, and radially faces the radially inner surface of the protruding wall portion 12 with a gap.

The bearing 311 has a tip portion 313. The tip portion 313 is a portion of one axial end of the bearing 311 on the radially inward Di side of the recess 312 (that is, a portion that is not cut out). The tip portion 313 is a metal tubular member extending in the axial direction and surrounding the shaft 10. The tip portion 313 is disposed radially inward Di of the protruding wall portion 12 of the rotor 1, and radially faces the protruding wall portion 12 with a gap. The radially outer surface of the tip portion 313 can be rephrased as a radially inner surface of the recess 312 (that is, an inner surface facing radially outward Do). In the present example embodiment, the tip portion 313 is a part of the bearing 311. However, the present disclosure is not limited to this example. The tip portion 313 may be a member separate from the bearing 311 and may be disposed on the radially inward Di side of one axial end surface of the bearing 311.

The present disclosure is not limited to the example of the present example embodiment. One axial end of the stator holder 31 may be disposed radially inward Di of the protruding wall portion 12 of the rotor 1. That is, one axial end of the stator holder 31 may be inserted into the inside (radially inward side) of the protruding wall portion 12 (particularly, a portion on the other axial direction Db side) and surrounded by the protruding wall portion 12.

Next, the base portion 32 is disposed in the other axial direction Db side with respect to the stator 2 and extends radially outward Do from the stator holder 31. As described above, the housing 3 includes the base portion 32.

The second peripheral wall portion 33 is a metal cylindrical member extending in the axial direction and surrounds the central axis CA. The second peripheral wall portion 33 extends in one axial direction Da from one axial end surface of the base portion 32 and surrounds the stator 2. As described above, the housing 3 has the second peripheral wall portion 33. For example, a portion of the second peripheral wall portion 33 on the other axial direction Db side is formed integrally with at least the base portion 32 by insert molding or the like. Alternatively, a portion of the second peripheral wall portion 33 on the other axial direction Db side may be inserted into an annular recess disposed on one axial end surface of the base portion 32 and fixed to the base portion 32 by means of press fitting, adhesion, or the like.

The second peripheral wall portion 33 is disposed radially outward Do with respect to the first peripheral wall portion 15. The first peripheral wall portion 15 (particularly, a portion on the other axial direction Db side) is inserted into the second peripheral wall portion 33 (radially inward side), and radially faces the second peripheral wall portion 33 with a gap.

The present disclosure is not limited to the example of the present example embodiment. The second peripheral wall portion 33 may be disposed radially inward Di with respect to the first peripheral wall portion 15 as long as the second peripheral wall portion 33 does not contact the magnet 16 and the stator 2. That is, the second peripheral wall portion 33 may be inserted into the inside (radially inward side) of the first peripheral wall portion 15 (particularly, a portion on the other axial direction Db side) and surrounded by the first peripheral wall portion 15.

The circuit board 4 is disposed on the other axial direction Db side of the base portion 32 on the radially outward Do side of the stator holder 31. The circuit board 4 is electrically connected to a lead wire (reference numeral is omitted) drawn out from the coil 23. A drive circuit of the stator 2 and the like are mounted on the circuit board 4. The circuit board 4 is electrically connected to an external wiring 41, and is covered with the covering portion 42 made of resin together with the connection end of the external wiring 41. The external wiring 41 is drawn out to the outside of the motor 101, and electrically connects the circuit board 4 to an external device, a power supply, and the like.

The labyrinth portion 5 suppresses or prevents passage of water and dust inside and outside the labyrinth portion 5. The labyrinth portion 5 has a pair of metal cylindrical portions surrounding the central axis CA. One of the pair of metal cylindrical portions has a pair of opposing surfaces fi and fo one of which surrounds the other. The pair of opposing surfaces fi and fo face each other in the radial direction with a gap therebetween.

Thus, for example, as compared with the case where the pair of cylindrical portions is made of resin, the metal cylindrical member has high dimensional accuracy, and thus dimensional tolerance can be further reduced. Therefore, it is possible to further reduce the gap while securing the gap between the pair of opposing surfaces fi and fo. Therefore, it is possible to suppress or prevent entry of water and dust from the radially outward Do side to the radially inward Di side of the labyrinth portion 5.

The labyrinth portion 5 includes a first labyrinth portion 51, a second labyrinth portion 52, and a third labyrinth portion 53.

As illustrated in FIG. 3, the first labyrinth portion 51 is formed in a gap between the protruding wall portion 12 (particularly, a portion on the other axial direction Db side) and one axial end of the stator holder 31. One of the pair of metal cylindrical portions included in the first labyrinth portion 51 is the protruding wall portion 12, and the other is the stator holder 31. As described above, the labyrinth portion 5 includes the first labyrinth portion 51. The first labyrinth portion 51 includes a pair of first opposing surfaces fi1 and fo1.

In the present example embodiment, the pair of first opposing surfaces fi1 and fo1 include the radially outer surface of the protruding wall portion 12 and the radially inner surface of the one axial end of the stator holder 31 that faces the radially outer surface with a gap therebetween in the radial direction. Specifically, in the radially outer surface of the protruding wall portion 12, a region overlapping the radially inner surface of the one axial end of the stator holder 31 when viewed from the radial direction is referred to as the “first opposing surface fi1”. In the radially inner surface of the one axial end of the stator holder 31, a region overlapping the radially outer surface of the protruding wall portion 12 when viewed from the radial direction is referred to as the “first opposing surface fo1”. That is, the pair of first opposing surfaces fi1 and fo1 include the first opposing surface fi1 of the protruding wall portion 12 and the first opposing surface fo1 of the stator holder 31.

The present disclosure is not limited to the example of the present example embodiment. One axial end of the stator holder 31 may be disposed radially inward Di of the protruding wall portion 12 of the rotor 1. That is, one axial end of the stator holder 31 may be inserted into the inside (radially inward side) of the protruding wall portion 12 (particularly, a portion on the other axial direction Db side). However, in this case, the second labyrinth portion 52 and second opposing surfaces fi2 and fo2 to be described later are not arranged. That is, the labyrinth portion 5 does not include the second labyrinth portion 52. The pair of opposing surfaces fi and fo does not include the pair of second opposing surfaces fi2 and fo2. In this case, the first opposing surface fi1 is the radially outer surface of the one axial end of the stator holder 31, and more specifically, is a region overlapping the radially inner surface of the protruding wall portion 12 when viewed from the radial direction among the radially outer surfaces of the one axial end of the stator holder 31. In addition, the first opposing surface fo1 is a radially inner surface of the protruding wall portion 12, and specifically, is a region overlapping a radially outer surface of one axial end of the stator holder 31 when viewed from the radial direction among the radially inner surfaces of the protruding wall portion 12.

That is, one cylindrical portion of the protruding wall portion 12 and the stator holder 31 may surround the other cylindrical portion. In this case, the pair of first opposing surfaces fi1 and fo1 includes a radially inner surface of one tubular portion and a radially outer surface of the other tubular portion. In addition, the radially inner surface of one tubular portion opposes the radially outer surface of the other tubular portion in the radial direction with a gap.

The second labyrinth portion 52 is formed in a gap between the radially inner surface (that is, the inner surface facing radially outward Do) of the recess 312 and the radially inner surface of the protruding wall portion 12. One of the pair of metal cylindrical portions included in the second labyrinth portion 52 is the protruding wall portion 12, and the other is the stator holder 31. As described above, the labyrinth portion 5 includes the second labyrinth portion 52. The second labyrinth portion 52 includes a pair of second opposing surfaces fi2 and fo2.

The pair of second opposing surfaces fi2 and fo2 includes a radially inner surface of the recess 312 and a radially inner surface of the protruding wall portion 12 facing the radially inner surface with a gap therebetween. Specifically, in the radially inner surface of the recess 312, a region overlapping the radially inner surface of the protruding wall portion 12 when viewed from the radial direction is referred to as the “second opposing surface fi2”. In the radially inner surface of the protruding wall portion 12, a region overlapping the radially inner surface of the recess 312 when viewed from the radial direction is referred to as the “second opposing surface fo2”. That is, the pair of second opposing surfaces fi2 and fo2 includes the second opposing surface fi2 of the recess 312 and the second opposing surface fo2 of the protruding wall portion 12.

As illustrated in FIG. 4, the third labyrinth portion 53 is formed in a gap between the first peripheral wall portion 15 (particularly, a portion on the other axial direction Db side) and the second peripheral wall portion 33. One of the pair of metal cylindrical portions included in the third labyrinth portion 53 is the first peripheral wall portion 15, and the other is the second peripheral wall portion 33. As described above, the labyrinth portion 5 includes the third labyrinth portion 53. The third labyrinth portion 53 includes a pair of third opposing surfaces fi3 and fo3.

In the present example embodiment, the pair of third opposing surfaces fi3 and fo3 includes the radially outer surface of the first peripheral wall portion 15 and the radially inner surface of the second peripheral wall portion 33. Specifically, in the radially outer surface of the first peripheral wall portion 15, a region overlapping the radially inner surface of the second peripheral wall portion 33 when viewed from the radial direction is referred to as the “third opposing surface fi3”. In the radially inner surface of the second peripheral wall portion 33, a region overlapping the radially outer surface of the first peripheral wall portion 15 when viewed from the radial direction is referred to as the “third opposing surface fo3”. That is, the pair of third opposing surfaces fi3 and fo3 is constituted of the third opposing surface fi3 of the first peripheral wall portion 15 and the third opposing surface fo3 of the second peripheral wall portion 33.

The present disclosure is not limited to the example of the present example embodiment. The second peripheral wall portion 33 may be disposed radially inward Di with respect to the first peripheral wall portion 15 as long as the second peripheral wall portion 33 does not contact the magnet 16 and the stator 2. That is, the second peripheral wall portion 33 may be inserted into the inside (radially inward side) of the first peripheral wall portion 15 (particularly, a portion on the other axial direction Db side). In this case, the third opposing surface fi3 is the radially outer surface of the second peripheral wall portion 33, and specifically, is a region overlapping the radially inner surface of the first peripheral wall portion 15 when viewed from the radial direction among the radially outer surfaces of the second peripheral wall portion 33. In addition, the third opposing surface fo3 is a radially inner side surface of the first peripheral wall portion 15, and specifically, is a region overlapping the radially outer surface of the second peripheral wall portion 33 when viewed from the radial direction among the radially inner side surfaces of the first peripheral wall portion 15.

That is, one peripheral wall portion of the first peripheral wall portion 15 and the second peripheral wall portion 33 may surround the other peripheral wall portion. In this case, the pair of third opposing surfaces fi3 and fo3 includes a radially inner surface of one peripheral wall portion and a radially outer surface of the other peripheral wall portion. In addition, the radially inner surface of one peripheral wall portion faces the radially outer surface of the other peripheral wall portion in the radial direction with a gap.

Preferably, the axial width W (see FIG. 4) of the pair of third opposing surfaces fi3 and fo3 is longer than the axial length L3 (see FIG. 3) of the protruding wall portion 12. In detail, the axial width W is a width in the axial direction of a region overlapping the radially inner surface of the second peripheral wall portion 33 when viewed from the radial direction among the radially outer surfaces of the first peripheral wall portion 15. In other words, the axial width W is a width in the axial direction of a region overlapping the radially outer surface of the first peripheral wall portion 15 as viewed from the radial direction among the radially inner surfaces of the second peripheral wall portion 33. Thus, the axial width W of the pair of third opposing surfaces fi3 and fo3 can be increased. Therefore, it is possible to improve an effect of suppressing or preventing intrusion of water and dust into the motor 101 (particularly the stator 2).

Next, the radial width of the gap between the pair of opposing surfaces fi and fo is preferably equal to or smaller than the radial width of at least one of the pair of metal cylindrical portions included in the labyrinth portion 5, and more preferably equal to or smaller than the radial width of both of the pair of metal cylindrical portions. Since the radial width of the gap between the pair of opposing surfaces fi and fo is small, it is possible to more effectively suppress or prevent water and dust from passing through the labyrinth portion 5.

For example, as illustrated in FIG. 3, in the first labyrinth portion 51, the radial width Wr1 of the gap between the pair of first opposing surfaces fi1 and fo1 is preferably equal to or smaller than at least one of the radial width d1 of the protruding wall portion 12 and the radial width d2 of one axial end of the stator holder 31, and more preferably equal to or smaller than both the radial widths d1 and d2. Since the radial width Wr1 of the gap between the pair of first opposing surfaces fi1 and fo1 is small, it is possible to more effectively suppress or prevent water and dust from passing through the first labyrinth portion 51.

As illustrated in FIG. 3, in the second labyrinth portion 52, the radial width Wr2 of the gap between the pair of second opposing surfaces fi2 and fo2 is preferably equal to or smaller than at least one of the radial width d1 of the protruding wall portion 12 and the radial width d3 of one axial end (that is, the tip portion 313) of the bearing 311, and more preferably equal to or smaller than both the radial widths d1 and d3. Since the radial width Wr2 of the gap between the pair of second opposing surfaces fi2 and fo2 is small, it is possible to more effectively suppress or prevent water and dust from passing through the second labyrinth portion 52.

As illustrated in FIG. 4, in the third labyrinth portion 53, the radial width Wr3 of the gap between the pair of third opposing surfaces fi3 and fo3 is preferably equal to or smaller than at least one of the radial width d4 of the first peripheral wall portion 15 and the radial width d5 of the second peripheral wall portion 33, and more preferably equal to or smaller than both the radial widths d4 and d5. Since the radial width Wr3 of the gap between the pair of third opposing surfaces fi3 and fo3 is small, it is possible to more effectively suppress or prevent water and dust from passing through the third labyrinth portion 53.

Next, the water-repellent layer 6 will be described with reference to FIGS. 1 and 3 to 4. The water-repellent layer 6 is a film having water repellency, and has a tubular shape extending in the axial direction. In the present example embodiment, the water-repellent layer 6 is a coating film of a water-repellent agent. Thus, the water-repellent layer 6 can be formed by a simple means. However, the material of the water-repellent layer 6 and the method of disposing the water-repellent layer 6 are not limited to these examples. The material of the water-repellent layer 6 only needs to have water repellency, and may be, for example, a fluorine-based resin or oil, a silicone-based resin or oil, a water-repellent ceramic, or the like. The water-repellent layer 6 may be disposed by spraying, dipping, physical vapor deposition, chemical vapor deposition, or the like.

The water-repellent layer 6 is disposed on at least one of the pair of opposing surfaces fi and fo. As described above, the motor 101 includes the water-repellent layer 6. The arrangement of the water-repellent layer 6 that repels water can suppress or prevent water from passing through the gap between the pair of opposing surfaces fi and fo.

On the opposing surface fi, the cylindrical water-repellent layer 6 may be disposed in an arbitrary partial region in the axial direction, or may be disposed in the entire region of the opposing surface fi. Similarly, on the opposing surface fo, the cylindrical water-repellent layer 6 may be disposed in a partial region in the axial direction or in the entire region in the axial direction.

Preferably, as in the present example embodiment, the water-repellent layer 6 is disposed on both of the pair of opposing surfaces fi and fo. In this case, the axial width of the water-repellent layer 6 disposed on the facing surface fi may be equal to the axial width of the water-repellent layer 6 disposed on the facing surface fo, or may be smaller or larger than the axial width of the water-repellent layer 6 disposed on the opposing surface fo. When viewed from the radial direction, at least a part of the water-repellent layer 6 disposed on the facing surface fi may or may not overlap at least a part of the water-repellent layer 6 disposed on the facing surface fo. That is, in the latter case, the arrangement of the water-repellent layer 6 disposed on the facing surface fi may be axially shifted from the arrangement of the water-repellent layer 6 disposed on the facing surface fo.

The water-repellent layer 6 includes a first water-repellent layer 61, a second water-repellent layer 62, and a third water-repellent layer 63.

The first water-repellent layer 61 is a film having water repellency, and has a tubular shape extending in the axial direction. In the first labyrinth portion 51, the first water-repellent layer 61 is disposed on at least one of the pair of first opposing surfaces fi1 and fo1. As described above, the water-repellent layer 6 includes the first water-repellent layer 61. The first water-repellent layer 61 can more effectively suppress or prevent water from entering the shaft 10, the bearing 311, and between the shaft and the bearing. Since the pair of first opposing surfaces fi1 and fo1 are outer surfaces of the protruding wall portion 12 and one axial end of the stator holder 31, respectively, the first water-repellent layer 61 can be easily disposed before the motor 101 is assembled.

On the first opposing surface fi1, the cylindrical first water-repellent layer 61 may be disposed in an arbitrary partial region in the axial direction as illustrated in FIG. 3, or may be disposed in the entire region in the axial direction. Similarly, on the first opposing surface fo1, the cylindrical first water-repellent layer 61 may be disposed in an arbitrary partial region in the axial direction or in the entire region in the axial direction. The cylindrical first water-repellent layer 61 may also be disposed in a region other than the first opposing surface fi1 on a radially side surface (the radially outer surface in FIG. 3) of the protruding wall portion 12, or may also be disposed in a region other than the first opposing surface fo1 on a radially side surface (the radially inner surface in FIG. 3) of one axial end of the stator holder 31.

Preferably, as illustrated in FIG. 3, the first water-repellent layer 61 is disposed on both of the pair of first opposing surfaces fi1 and fo1. In this case, the axial width of the first water-repellent layer 61 disposed on the first opposing surface fi1 may be the same as the axial width of the first water-repellent layer 61 disposed on the first opposing surface fo1, or may be smaller or larger than the axial width of the first water-repellent layer 61 disposed on the first opposing surface fo1. When viewed from the radial direction, at least a part of the first water-repellent layer 61 disposed on the first opposing surface fi1 may or may not overlap at least a part of the first water-repellent layer 61 disposed on the first opposing surface fo1. That is, in the latter case, the arrangement of the first water-repellent layer 61 on the first opposing surface fi1 may be axially shifted from the arrangement of the first water-repellent layer 61 on the first opposing surface fo1. However, this example does not exclude a configuration in which the first water-repellent layer 61 is not disposed on at least one of the pair of first opposing surfaces fi1 and fo1.

The second water-repellent layer 62 is a film having water repellency, and has a tubular shape extending in the axial direction. In the second labyrinth portion 52, the second water-repellent layer 62 is disposed on at least one of the pair of second opposing surfaces fi2 and fo2. As described above, the water-repellent layer 6 includes the second water-repellent layer 62. The second water-repellent layer 62 can more effectively suppress or prevent water from entering between the shaft 10 and the bearing 311 and into the shaft 10. Since the pair of second opposing surfaces fi2 and fo2 are outer surfaces of the bearing 311 and the protruding wall portion 12, respectively, the second water-repellent layer 62 can be easily disposed before the motor 101 is assembled.

On the second opposing surface fi2, the cylindrical second water-repellent layer 62 may be disposed in an arbitrary partial region in the axial direction as illustrated in FIG. 3, or may be disposed in the entire region in the axial direction. Similarly, on the second opposing surface fo2, the cylindrical second water-repellent layer 62 may be disposed in an arbitrary partial region in the axial direction or in the entire region in the axial direction. The cylindrical second water-repellent layer 62 may also be disposed in a region other than the second opposing surface fi2 on the radially inner surface (that is, the radially outer surface of the tip portion 313) of the recess 312 of the bearing 311, or may also be disposed in a region other than the second opposing surface fo2 on the radially inner surface of the protruding wall portion 12.

Preferably, as illustrated in FIG. 3, the second water-repellent layer 62 is disposed on both of the pair of second opposing surfaces fi2 and fo2. In this case, the axial width of the second water-repellent layer 62 disposed on the second opposing surface fi2 may be equal to the axial width of the second water-repellent layer 62 disposed on the second opposing surface fo2, or may be smaller or larger than the axial width of the second water-repellent layer 62 disposed on the second opposing surface fo2. When viewed from the radial direction, at least a part of the second water-repellent layer 62 disposed on the second opposing surface fi2 may or may not overlap at least a part of the second water-repellent layer 62 disposed on the second opposing surface fo2. That is, in the latter case, the arrangement of the second water-repellent layer 62 on the second opposing surface fi2 may be axially shifted from the arrangement of the second water-repellent layer 62 on the second opposing surface fo2. However, this example does not exclude a configuration in which the second water-repellent layer 62 is not disposed on at least one of the pair of second opposing surfaces fi2 and fo2.

The third water-repellent layer 63 is a film having water repellency, and has a cylindrical shape extending in the axial direction. In the third labyrinth portion 53, the third water-repellent layer 63 is disposed on at least one of the pair of third opposing surfaces fi3 and fo3. As described above, the water-repellent layer 6 includes the third water-repellent layer 63. The third water-repellent layer 63 can more effectively suppress or prevent water from entering the inside of the motor 101 (particularly, the stator 2). By forming the third water-repellent layer 63 on at least one of the third opposing surfaces fi3 and fo3 before assembling the motor 101, the third water-repellent layer 63 can be easily disposed.

On the third opposing surface fi3, the cylindrical third water-repellent layer 63 may be disposed in an arbitrary partial region in the axial direction as illustrated in FIG. 4, or may be disposed in the entire region in the axial direction. Similarly, on the third opposing surface fo3, the cylindrical third water-repellent layer 63 may be disposed in an arbitrary partial region in the axial direction or in the entire region in the axial direction. The third water-repellent layer 63 having a cylindrical shape may also be disposed in a region other than the third opposing surface fi3 on the radially side surface (the radially outer surface in FIG. 4) of the first peripheral wall portion 15, or may also be disposed in a region other than the third opposing surface fo3 on the radially side surface (the radially inner surface in FIG. 4) of the second peripheral wall portion 33.

Preferably, as illustrated in FIG. 4, the third water-repellent layer 63 is disposed on both of the pair of third opposing surfaces fi3 and fo3. In this case, the axial width of the third water-repellent layer 63 disposed on the third opposing surface fi3 may be equal to the axial width of the third water-repellent layer 63 disposed on the third opposing surface fo3, or may be smaller or larger than the axial width of the third water-repellent layer 63 disposed on the third opposing surface fo3. When viewed from the radial direction, at least a part of the third water-repellent layer 63 disposed on the third opposing surface fi3 may or may not overlap at least a part of the third water-repellent layer 63 disposed on the third opposing surface fo3. That is, in the latter case, the arrangement of the third water-repellent layer 63 on the third opposing surface fi3 may be axially shifted from the arrangement of the third water-repellent layer 63 on the third opposing surface fo3. However, this example does not exclude a configuration in which the third water-repellent layer 63 is not disposed on at least one of the pair of third opposing surfaces fi3 and fo3.

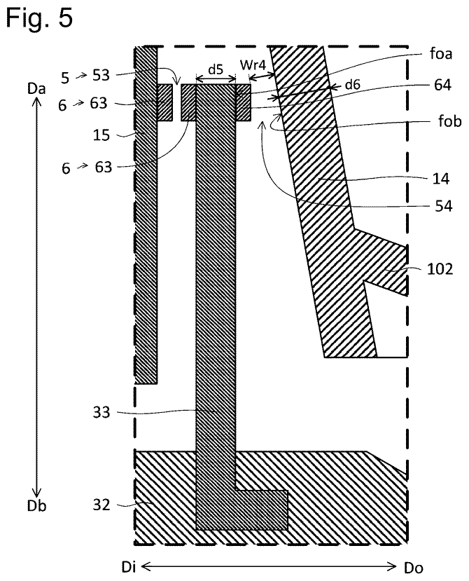

Next, as illustrated in FIGS. 1 and 5, the motor 101 further includes an outer labyrinth portion 54 and an outer water-repellent layer 64. FIG. 5 is an enlarged cross-sectional view of a portion V surrounded by a broken line in FIG. 1.

The outer labyrinth portion 54 is formed between the second peripheral wall portion 33 and the rotor cylindrical portion 14. The outer labyrinth portion 54 has a pair of cylindrical portions surrounding the central axis CA. One of the pair of cylindrical portions is the second peripheral wall portion 33 made of metal, and the other is the rotor cylindrical portion 14 made of resin. One of the pair of cylindrical portions has a pair of outer opposing surfaces foa and fob one of which surrounds the other. The pair of outer opposing surfaces foa and fob face each other in the radial direction with a gap therebetween. The outer labyrinth portion 54 includes the pair of outer opposing surfaces foa and fob. In the present example embodiment, the pair of outer opposing surfaces foa and fob are configured of the radially outer surface of the second peripheral wall portion 33 and the radially inner surface of the rotor cylindrical portion 14. Specifically, in the radially outer surface of the second peripheral wall portion 33, a region overlapping the radially inner surface of the rotor cylindrical portion 14 when viewed from the radial direction is referred to as the “outer opposing surface foa”. In the radially inner surface of the second peripheral wall portion 33, a region overlapping the radially inner surface of the rotor cylindrical portion 14 when viewed from the radial direction is referred to as the “outer opposing surface fob”. That is, the pair of outer opposing surfaces foa and fob is configured of the outer opposing surface foa of the second peripheral wall portion 33 and the outer opposing surface fob of the rotor cylindrical portion 14.

As illustrated in FIG. 5, a minimum radial width Wr4 in the gap between the pair of outer opposing surfaces foa and fob is preferably equal to or smaller than at least one of the radial width d5 of the second peripheral wall portion 33 and a thickness d6 of the rotor cylindrical portion 14, and more preferably equal to or smaller than both the widths d5 and d6. The thickness d6 of the rotor cylindrical portion 14 is a width in a direction perpendicular to the direction in which the rotor cylindrical portion 14 extends when viewed from the circumferential direction. Accordingly, since the radial width Wr4 between the pair of outer opposing surfaces foa and fob can be further narrowed, it is possible to more effectively suppress or prevent water and dust from passing through the outer labyrinth portion 54.

The outer water-repellent layer 64 is a film having water repellency, and has a cylindrical shape extending in the axial direction. In the present example embodiment, the outer water-repellent layer 64 is a coating film of a water-repellent agent. Thus, the outer water-repellent layer 64 can be formed by a simple means. However, the material and arrangement method of the outer water-repellent layer 64 are not limited to these examples. The material of the outer water-repellent layer 64 only needs to have water repellency, and may be, for example, a fluorine-based resin or oil, a silicone-based resin or oil, a water-repellent ceramic, or the like. The outer water-repellent layer 64 may be disposed by spraying, dipping, physical vapor deposition, chemical vapor deposition, or the like.

In the outer labyrinth portion 54, the outer water-repellent layer 64 is disposed on at least one of the pair of outer opposing surfaces foa and fob. In the present example embodiment, as illustrated in FIG. 5, the outer water-repellent layer 64 is disposed on the outer opposing surface foa of the second peripheral wall portion 33, but is preferably disposed on both of the pair of outer opposing surfaces foa and fob. The outer water-repellent layer 64 can more effectively prevent water from entering the motor 101 from the outside to the inside. Since the pair of outer opposing surfaces foa and fob are outer surfaces of the second peripheral wall portion 33 and the rotor cylindrical portion 14, respectively, the outer water-repellent layer 64 can be easily disposed before the motor 101 is assembled.

On the outer opposing surface foa, the cylindrical outer water-repellent layer 64 may be disposed in an arbitrary partial region in the axial direction as illustrated in FIG. 5, or may be disposed in the entire region in the axial direction. Similarly, on the outer opposing surface fob, the cylindrical outer water-repellent layer 64 may be disposed in any partial region in the axial direction or in the entire region in the axial direction. The cylindrical outer water-repellent layer 64 may also be disposed in a region other than the outer opposing surface foa on the radially outer surface of the second peripheral wall portion 33, or may also be disposed in a region other than the outer opposing surface fob on the radially inner surface of the rotor cylindrical portion 14.

When the outer water repellent layer 64 is disposed on both of the pair of outer opposing surfaces foa and fob, the axial width of the outer water repellent layer 64 disposed on the outer opposing surface foa may be equal to the axial width of the outer water repellent layer 64 disposed on the outer opposing surface fob, or may be smaller or larger than the axial width of the outer water repellent layer 64 disposed on the outer opposing surface fob. When viewed in the radial direction, at least a part of the outer water-repellent layer 64 disposed on the outer opposing surface foa may or may not overlap at least a part of the outer water-repellent layer 64 disposed on the outer opposing surface fob. That is, in the latter case, the arrangement of the outer water-repellent layer 64 on the outer opposing surface foa may be axially shifted from the arrangement of the outer water-repellent layer 64 on the outer opposing surface fob.

However, the above-described example does not exclude a configuration in which the outer water-repellent layer 64 is not disposed on both of the pair of outer opposing surfaces foa and fob. For example, the outer water-repellent layer 64 may be omitted.

Example embodiments of the present disclosure have been described above. It is to be noted that the scope of the present disclosure is not limited to the above-described example embodiments. The present disclosure can be implemented by making various modifications to the above-described example embodiments within a range not departing from the gist of the disclosure. Further, the matters described in the above-described example embodiments are arbitrarily combined together as appropriate within a range where no inconsistency occurs.

The example embodiments described above will be collectively described below. For example, a motor disclosed herein has a configuration (first configuration) including:
a rotor rotatable about a central axis extending in an axial direction;
a stator including a stator core in which coils aligned in a circumferential direction are located; and
a labyrinth portion including a pair of metal cylindrical portions surrounding the central axis, in which
the pair of metal cylindrical portions includes a pair of opposing surfaces that oppose each other in a radial direction with a gap therebetween, and one of the opposing surfaces surrounds the other.

Note that the motor having the first configuration may have a configuration (second configuration) in which
a radial width of the gap between the pair of opposing surfaces may be equal to or smaller than a radial width of at least one of the pair of metal cylindrical portions.

Further, the motor having the first or second configuration may have a configuration (third configuration) further including
a water-repellent layer located on at least one of the pair of opposing surfaces.

Further, the motor having the third configuration may have a configuration (fourth configuration) further including
a stator holder with a cylindrical shape, the stator holder extending in an axial direction, surrounding the central axis, and supporting the stator core, in which
the rotor includes:
   a shaft extending along the central axis and rotatable about the central axis;
   a rotor hub extending radially outward from one axial end of the shaft; and
   a protruding wall portion with a cylindrical shape, the protruding wall portion extending in another axial direction from another axial end surface of the rotor hub, and surrounding one axial end of the bearing;
a cylindrical portion of one of the protruding wall portion and the stator holder surrounds a cylindrical portion of another of the protruding wall portion and the stator holder;
the labyrinth portion includes a first labyrinth portion including a pair of first opposing surfaces;
the pair of opposing surfaces includes the pair of first opposing surfaces;
the pair of first opposing surfaces includes a radially inner surface of the one cylindrical portion and a radially outer surface of the other cylindrical portion;
the radially inner surface of the one cylindrical portion opposes the radially outer surface of the other cylindrical portion in a radial direction with a gap; and
the water-repellent layer includes a first water-repellent layer located on at least one of the pair of first opposing surfaces.

Further, the motor having the third or fourth configuration may have a configuration (fifth configuration) further including:
a stator holder with a cylindrical shape, the stator holder extending in an axial direction and supporting the stator core; and
a bearing located on an inner peripheral surface of the stator holder, in which
the bearing includes a recess having a cylindrical shape surrounding the central axis;
the recess is recessed in the other axial direction at one axial end of the bearing and is open radially outward;
the rotor includes:
   a shaft extending along the central axis and rotatably supported by the bearing;
   a rotor hub extending radially outward from one axial end of the shaft; and
   a protruding wall portion having a cylindrical shape, extending in the other axial direction from another axial end surface of the rotor hub, and surrounding one axial end portion of the bearing;
the labyrinth portion includes a second labyrinth portion including a pair of second opposing surfaces;
the pair of opposing surfaces includes the pair of second opposing surfaces;
the pair of second opposing surfaces includes a radially inner surface of the recess and a radially inner surface of the protruding wall portion that opposes the radially inner surface in the radial direction with a gap; and
the water-repellent layer includes a second water-repellent layer located on at least one of the pair of second opposing surfaces.

Further, the motor having any of the third to fifth configurations may have a configuration (sixth configuration) further including
a housing including a stator holder extending in an axial direction and supporting the stator core, in which
the rotor includes:
a rotor lid located on one axial side with respect to the stator and extending in the radial direction; and
a first peripheral wall portion having a cylindrical shape, the first peripheral wall portion extending in another axial direction from another axial end surface of the rotor lid and surrounding the stator,
the housing includes:
a base portion located on another axial side with respect to the stator and extending radially outward from the stator holder; and
a second peripheral wall portion extending in the one axial direction from one axial end surface of the base portion and surrounding the stator;
one peripheral portion of the first peripheral wall portion and the second peripheral portion surrounds another peripheral portion of the first peripheral wall portion and the second peripheral portion;
the labyrinth portion includes a third labyrinth portion including a pair of third opposing surfaces;
the pair of opposing surfaces includes the pair of third opposing surfaces;
the pair of third opposing surfaces includes a radially inner surface of the one peripheral wall portion and a radially outer surface of the other peripheral portion;
the radially inner surface of the one peripheral wall portion opposes the radially outer surface of the other peripheral wall portion in a radial direction with a gap; and
the water-repellent layer includes a third water-repellent layer located on at least one of the pair of third opposing surfaces.

Further, the motor having the sixth configuration may have a configuration (seventh configuration) further including
a bearing located on an inner peripheral surface of the stator holder, in which
the rotor includes:
   a shaft extending along the central axis and rotatably supported by the bearing;
   a rotor hub extending radially outward from one axial end of the shaft; and
   a protruding wall portion in a tubular shape, the protruding wall portion extending in the other axial direction from another axial end surface of the rotor hub and surrounding one axial end of the bearing; and
an axial width of the pair of third opposing surfaces is longer than an axial length of the protruding wall portion.

Further, the motor having the sixth or seventh configuration may have a configuration (eighth configuration) in which
the rotor includes:
   a rotor cylindrical portion extending from a radially outer end of the rotor lid to the other axial side; and
   a magnet located on a radially inner surface of the first peripheral wall portion and radially opposing the stator core;
the first peripheral wall portion is a cylindrical magnetic body extending in the axial direction;
a portion on one axial side of the first peripheral wall portion is connected to either one of the other axial end portion of the rotor lid and a radially inner end of the rotor cylindrical portion; and
an axial length of a portion of the first peripheral wall portion exposed from either one of the other axial end portion of the rotor lid and a radially inner end of the rotor cylindrical portion is longer than an axial length of the portion connected to either one of the other axial end portion of the rotor lid and a radially inner end of the rotor cylindrical portion.

Further, the motor having any of the third to eighth configurations may have a configuration (ninth configuration) in which
the water-repellent layer includes a coating film of a water-repellent agent.

Further, the blower disclosed in the present specification may have a configuration (tenth configuration) including:
the motor having any of the first to ninth configurations; and
a rotor blade rotatable about the central axis together with the rotor of the motor.

Example embodiments of the present disclosure provide techniques to reduce or prevent intrusion of water and dust into a motor.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a central axis extending in an axial direction;
a stator including a stator core in which coils aligned in a circumferential direction are located; and
a labyrinth portion including a pair of metal cylindrical portions surrounding the central axis; wherein
the pair of metal cylindrical portions includes a pair of opposing surfaces that oppose each other in a radial direction with a gap, and one of the pair of opposing surfaces surrounds another of the pair of opposing surfaces.

2. The motor according to claim 1, wherein a radial width of the gap between the pair of opposing surfaces is equal to or smaller than a radial width of at least one of the pair of metal cylindrical portions.

3. The motor according to claim 1, further comprising a water-repellent layer located on at least one of the pair of opposing surfaces.

4. The motor according to claim 3, further comprising:
a stator holder having a cylindrical shape, the stator holder extending in an axial direction, surrounding the central axis, and supporting the stator core; wherein
the rotor includes:
a shaft extending along the central axis and rotatable about the central axis;
a rotor hub extending radially outward from one axial end of the shaft; and
a protruding wall portion having a cylindrical shape and extending in another axial direction from another axial end surface of the rotor hub, the protruding wall portion surrounding one axial end of a bearing;
a cylindrical portion of one of the protruding wall portion and the stator holder surrounds a cylindrical portion of another of the protruding wall portion and the stator holder;
the labyrinth portion includes a first labyrinth portion including a pair of first opposing surfaces;
the pair of opposing surfaces includes the pair of first opposing surfaces;
the pair of first opposing surfaces includes a radially inner surface of the one tubular portion and a radially outer surface of the other tubular portion;
the radially inner surface of the one tubular portion opposes the radially outer surface of the other tubular portion in the radial direction with a gap; and
the water-repellent layer includes a first water-repellent layer located on at least one of the pair of first opposing surfaces.

5. The motor according to claim 3, further comprising:
a stator holder having a cylindrical shape, the stator holder extending in an axial direction and supporting the stator core; and
a bearing located on an inner peripheral surface of the stator holder; wherein
the bearing includes a recess having a cylindrical shape surrounding the central axis;
the recess is recessed in the other axial direction at one axial end of the bearing and is open radially outward;
the rotor includes:
a shaft extending along the central axis and rotatably supported by the bearing;
a rotor hub extending radially outward from one axial end of the shaft; and
a protruding wall portion having a cylindrical shape, the protruding wall portion extending in the other axial direction from another axial end surface of the rotor hub and surrounding one axial end portion of the bearing;
the labyrinth portion includes a second labyrinth portion including a pair of second opposing surfaces;
the pair of opposing surfaces includes the pair of second opposing surfaces;
the pair of second opposing surfaces includes a radially inner surface of the recess and a radially inner surface of the protruding wall portion that opposes the radially inner surface in the radial direction with a gap; and
the water-repellent layer includes a second water-repellent layer located on at least one of the pair of second opposing surfaces.

6. The motor according to claim 3, further comprising a housing including a stator holder, the stator holder extending in an axial direction and supporting the stator core, wherein the rotor includes:
a rotor lid located on one axial side with respect to the stator and extending in the radial direction; and
a first peripheral wall portion having a cylindrical shape, the first peripheral wall portion extending in another axial direction from another axial end surface of the rotor lid and surrounding the stator;
the housing includes:
a base portion located on another axial side with respect to the stator and extending radially outward from the stator holder; and
a second peripheral wall portion extending in the one axial direction from one axial end surface of the base portion and surrounding the stator;
one peripheral portion of the first peripheral wall portion and the second peripheral portion surrounds another peripheral portion of the first peripheral wall portion and the second peripheral portion;
the labyrinth portion includes a third labyrinth portion including a pair of third opposing surfaces;
the pair of opposing surfaces includes the pair of third opposing surfaces;
the pair of third opposing surfaces includes a radially inner surface of the one peripheral wall portion and a radially outer surface of the other peripheral portion;
the radially inner surface of the one peripheral wall portion faces the radially outer surface of the other peripheral wall portion in the radial direction with a gap; and
the water-repellent layer includes a third water-repellent layer located on at least one of the pair of third opposing surfaces.

7. The motor according to claim 6, further comprising a bearing located on an inner peripheral surface of the stator holder, wherein
the rotor includes:
a shaft extending along the central axis and rotatably supported by the bearing;
a rotor hub extending radially outward from one axial end of the shaft; and
a protruding wall portion with a cylindrical shape, the protruding wall portion extending in the other axial direction from another axial end surface of the rotor hub and surrounding one axial end of the bearing; and
an axial width of the pair of third opposing surfaces is longer than an axial length of the protruding wall portion.

8. The motor according to claim 6, wherein
the rotor includes:
a rotor cylindrical portion extending from a radially outer end of the rotor lid to the other axial side; and
a magnet located on a radially inner surface of the first peripheral wall portion and radially opposing the stator core;
the first peripheral wall portion is a cylindrical magnetic body extending in the axial direction;
a portion on one axial side of the first peripheral wall portion is connected to either one of the other axial end portion of the rotor lid and a radially inner end of the rotor cylindrical portion; and
an axial length of a portion of the first peripheral wall portion exposed from either one of the other axial end portion of the rotor lid and a radially inner end of the rotor cylindrical portion is longer than an axial length of the portion connected to either one of the other axial end portion of the rotor lid and the radially inner end of the rotor cylindrical portion.

9. The motor according to claim 3, wherein the water-repellent layer includes a coating film of a water-repellent agent.

10. A blower comprising:
the motor according to claim 1; and
a rotor blade rotatable about the central axis together with the rotor of the motor.
